(19) United States
(12) Patent Application Publication
(10) Pub. No.: US 2025/0162842 A1
(43) Pub. Date: May 22, 2025

(54) System & Method to Improve Productivity in Forestry Work Machine

(71) Applicant: Deere & Company, Moline, IL (US)

(72) Inventor: Sanket Pawar, Pune (IN)

(21) Appl. No.: 18/510,920

(22) Filed: Nov. 16, 2023

(51) Int. Cl. B66C 13/48; A01G 23/00; B66C 13/46; B66C 23/36

(52) U.S. Cl. CPC B66C 13/48; B66C 23/36; A01G 23/003; B66C 13/46

(57) ABSTRACT

A forestry work machine includes a main frame with an undercarriage. The main frame is supported by a swing bearing and is pivotable on the swing bearing relative to the undercarriage. A boom assembly is coupled to the forestry work machine and includes a working tool. A sensor detects an orientation of the working tool, and a controller coupled to the sensor is configured to adjust the working tool. The controller may adjust the working tool using an automatic mode or a semi-automatic mode.

### FIELD OF DISCLOSURE

The present disclosure relates to work machines, in particular, to self-propelled work machines associated with construction and forestry machines.

### BACKGROUND

Self-propelled work machines may, for example, include excavator machines, forestry machines, and front shovel machines, among others. These machines may typically have tracked ground engaging units supporting the undercarriage from the ground surface. In other examples, these machines may have wheels supporting the undercarriage from the ground surface.

Various situations arise with such machines where the human operator needs to perform repetitive operations (e.g., log pick and unload). These operations often require coordinated positioning of one or more work tools. Referring to an exemplary operation of a forester, after picking up a log the operator may provide one or more commands to align the grapple and thereby the log with the log truck, after which commands are provided to realign the grapple with the log pile and repeating the process.

It would be desirable to automate certain of the aforementioned coordinated operations, thereby increasing productivity and ease of operating the work machine, and further reducing operator fatigue from the repetitive operations.

### SUMMARY

According to one example of the present disclosure, a forestry work machine comprising: a frame supported by at least one ground engaging mechanism; a boom coupled to the frame and configured to move relative to the frame; a working tool coupled to the boom and configured to perform a work function; a controller for controlling movement of the boom and working tool; and a sensor communicatively coupled to the controller, the sensor configured to detect a characteristic of the working tool; wherein, when the working tool is in a first position, the sensor detects the characteristic of the working tool and communicates the characteristic to the controller; wherein the controller stores the characteristic as a first set point; wherein, when the working tool is displaced from the first position and the controller receives a command to return the working tool to the first position, the controller operatively 129299478v1 controls movement of the working tool to the first position based on the first set point.

In one example, the sensor may be configured to detect a second characteristic of the working tool at a second position and communicate the second position to the controller; wherein the controller stores the second characteristic as a second set point; wherein, when the working tool is displaced from the second position and the controller receives a command to return the working tool to the second position, the controller operatively controls movement of the working tool to the second position based on the second set point.

In one example, the controller may operably move the working tool via an automatic mode, wherein during the automatic mode the controller automatically moves the working tool to the first position without manual intervention. In some examples, the controller may move the working tool via a semi-automatic mode, wherein during the semi-automatic mode the controller is configured to enable a free swing mode until the working tool reaches the first position and disables the free swing mode once the working tool reaches the first position.

In one example, the characteristic of the working tool may include one or more of a rotational orientation of the working tool, an open or closed status of the working tool, a distance the working tool is relative to the frame, a position of the working tool relative to the frame, and a height of the working tool relative to a ground surface. In some examples, the working tool comprises a grapple. In one example, the sensor comprises one or more of a position sensor, proximity sensor, pressure sensor, motion sensor, image sensor, ultrasonic sensor, or GPS sensor.

In some examples, the forestry work machine may further comprise a free swing function button disposed in communication with the controller, wherein when the free swing button is actuated, the controller is configured to transition the working machine into or out of a free swing mode. In one example, the controller is configured to prioritize an instruction received from the free swing function button over an input received from the sensor.

According to some examples, a method for moving material via a forestry work machine from a first area to a second area, the forestry work machine including a boom, a working tool, and a controller, the method comprising: moving a working tool connected to the boom via the controller to a first position in the first area; storing, via the controller, a first characteristic of the working tool at the first position as a first set point; collecting the material with the working tool; moving the working tool via the controller to a second position in the second area; storing, via the controller, a second characteristic of the working tool at the second position as a second set point; and actuating the working tool via the controller to release the material in the second area.

In some examples, the method may further comprise: controllably moving the working tool via the controller towards the first area and in the first position based on the first set point; automatically stopping the working tool from moving once the working tool is in the first position based on the first set point; controllably lowering the working tool via the controller and collecting the material with the working tool; controllably moving the working tool via the controller towards the second area and moving the working tool to the second position based on the second set point; automatically stopping the movement of the working tool via the controller once the working tool reaches the second position; and lowering the working tool and releasing the material into the second area. In one example, controllably moving the working tool to the first and second positions is done via an automatic mode or a semi-automatic mode.

In some examples, in the automatic mode, the method comprises: enabling, via the controller, a rotate function that actively moves the working tool to the first or second set point, and disabling, via the controller, the rotate function when the working tool is in the first or second set point. In some examples, in the semi-automatic mode, the method comprises: activating, via the controller, a free swing function when the working tool is not in the first or second set point; and deactivating, via the controller, the free swing function once the working tool reaches the first or second set point. In one example, storing the first characteristic or the second characteristic of the working tool in the controller comprises storing one or more of a rotational orientation of the working tool, an open or closed status of the working tool, a distance the working tool is relative to the frame, a position of the working tool relative to the frame, and a height of the working tool relative to a ground surface.

According to one example, a method for moving a material into an area via a forestry work machine, the forestry work machine including a working tool and a controller, the method comprising: performing a first operation by controlling the working tool to move to a first location and collect a first load of material; storing a first characteristic of the working tool at the first location in the controller; controllably moving, via the controller, the working tool to a second location and recording a second characteristic of the working tool at the second location as a second set point in the controller; maintaining the working tool at the second set point until a command is received by the controller to move the working tool from the second set point and release the material at the second location; moving the working tool via the controller from the second location to the first location based on the first set point; and performing a second operation by controlling the working tool to collect a second load of material from the first area. In one example, the first operation comprises: controllably moving the working tool to a first position via the controller based on the first set point; and maintaining the working tool at the first set point until a command is given to move the working tool from the first set point. In some examples, the method comprises: controllably moving the working tool via the controller by activating a free swing mode; and automatically deactivating via the controller the free swing mode once the working tool reaches the first or second set point.

In one example, the method further comprising rotating, via the controller, the working tool to the first or second set point. In some examples, storing the first characteristic or the second characteristic of the working tool in the controller comprises storing one or more of a rotational orientation of the working tool, an open or closed status of the working tool, a distance the working tool is relative to the frame, a position of the working tool relative to the frame, and a height of the working tool relative to a ground surface.

The above and other features will become apparent from the following description and accompanying drawings.

### BRIEF DESCRIPTION OF THE DRAWINGS

The above-mentioned aspects of the present disclosure and the manner of obtaining them will become more apparent and the disclosure itself will be better understood by reference to the following description of the implementations of the disclosure, taken in conjunction with the accompanying drawings, wherein:

FIG. 1a is a front perspective view of a forestry swing machine including a grapple configured to grab, and release logs;

FIG. 1b is a rear perspective view of the forestry swing machine of FIG. 1;

FIG. 2 is a block diagram of one example of a forestry swing machine controller;

FIG. 3a is a block diagram for a swing machine control system that includes a passive rotate orientation;

FIG. 3b is a block diagram for a swing machine control system that includes an active and passive rotate orientation;

FIG. 3c is a second block diagram for a swing machine control system that includes active and passive rotate orientation;

FIG. 3d is a block diagram for a swing machine control system uses active and passive rotate orientation and also includes that includes a grapple orientation adjustment in response to boom position displacement;

FIG. 4a is a landing site with a first configuration including a log pile, a log truck, and a swing machine;

FIG. 4b is a landing site with a second configuration including the log pile, log truck, and swing machine;

FIG. 5 is a method for moving the grapple between the log pile and log truck including semi-automatic or automatic alignment mode to align the grapple;

FIG. 6a is a landing site with a third configuration including two log piles, one log truck, and the swing machine;

FIG. 6b is a landing site with a fourth configuration including two log piles, one log truck, and the swing machine;

FIG. 6c is a landing site with a fifth configuration including one log pile, two log trucks, and the swing machine;

FIG. 7 is block diagram of a method for moving one or more logs from one or more log piles to one or more log trucks; and

FIG. 8 is aside view of a forwarder configured to grab felled logs and store them in a log bunk.

Corresponding reference numerals are used to indicate corresponding parts throughout the several views.

### DETAILED DESCRIPTION

For the purposes of promoting an understanding of the principles of the present disclosure, reference will now be made to the implementations described herein and illustrated in the drawings and specific language will be used to describe the same. It will nevertheless be understood that no limitation of the scope of the present disclosure is thereby intended, such alterations and further modifications in the illustrated devices and methods, and such further applications of the principles of the present disclosure as illustrated therein being contemplated as would normally occur to one skilled in the art to which the present disclosure relates.

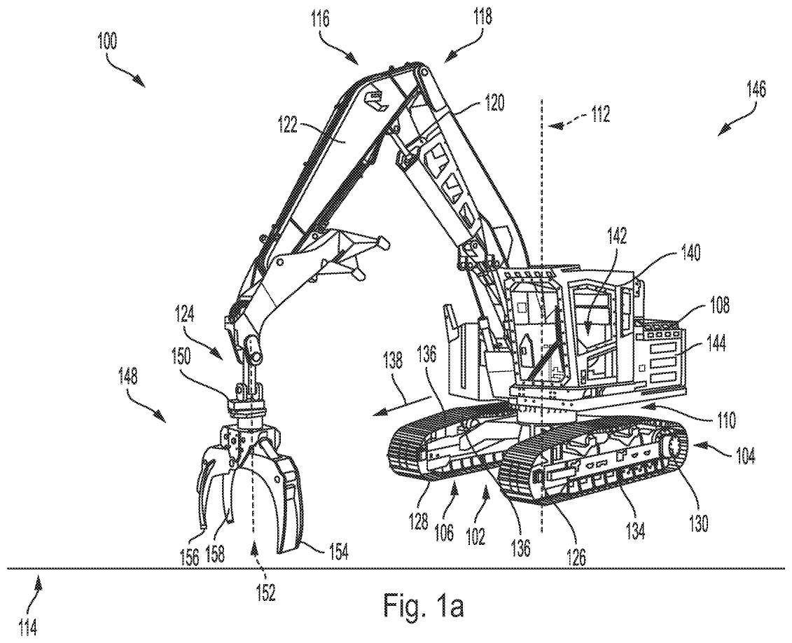

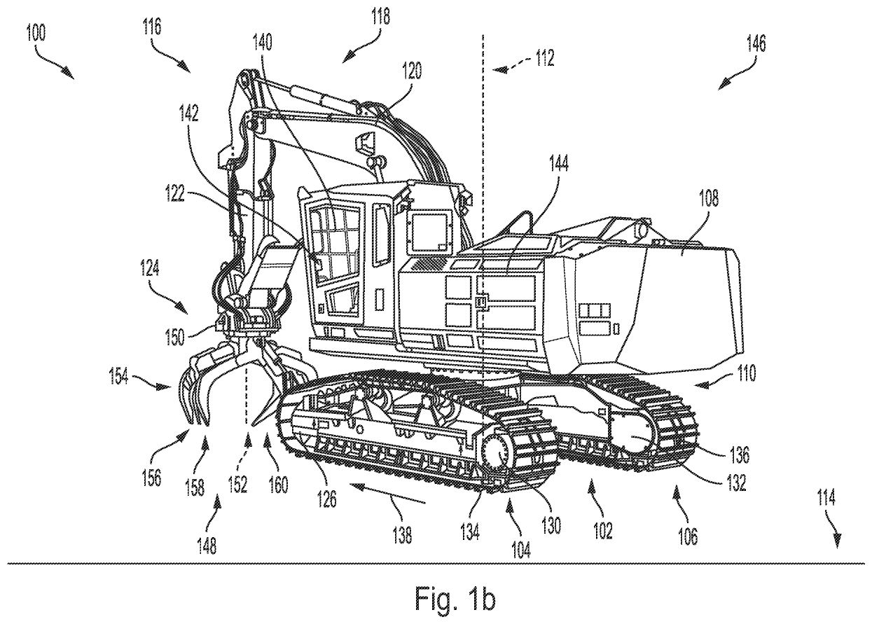

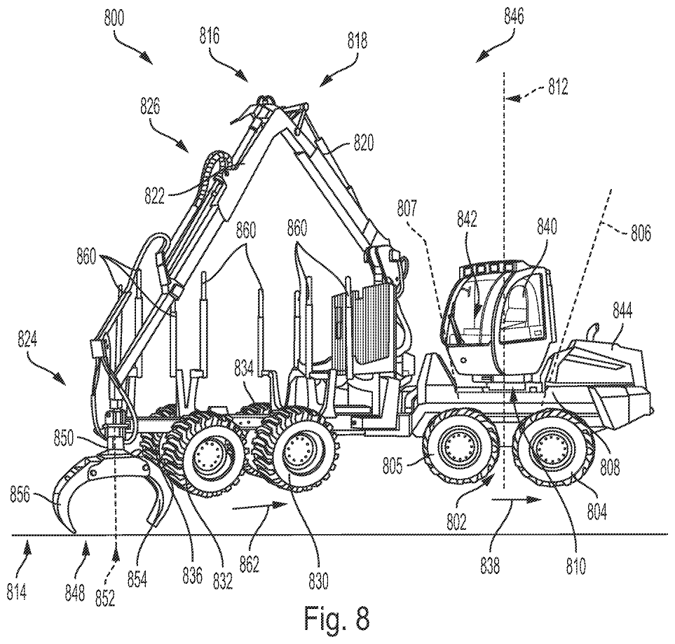

The method and the system according to the disclosure may be applied in a variety of work machines 100 equipped with a grapple 148, for example, in various forestry machines. The methods and systems may be applied, for example, to a forestry swing machine 146 as illustrated in FIGS. 1a and 1b, as well as in a forester as illustrated in FIG. 8.

Referring to FIGS. 1a and 1b, a self-propelled work machine 100 in the form of, for example, a forestry swing machine 146 is illustrated. The work machine 100 includes an undercarriage 102 including first and second ground engaging units 104, 106, including first and second travel motors (not shown) for driving the first and second ground engaging units 104, 106, respectively.

The work machine 100 may further include a main frame 108 supported from the undercarriage 102 by a swing bearing 110 such that the main frame 108 is pivotable about a pivot axis 112 relative to the undercarriage 102. The pivot axis 112 may be substantially vertical when a ground surface 114 is substantially horizontal. A swing motor (not shown) may be configured to pivot the main frame 108 on the swing bearing 110 about the pivot axis 112 relative to the undercarriage 102. The boom 120 may be pivotally attached to the main frame 108 to pivot about a generally horizontal axis relative to the main frame 108. The working tool 124 may be pivotally coupled to the boom arm 122. In one implementation, as illustrated in FIGS. 1a and 1b, the working tool 124 may be a grapple 148. The grapple 148 may be moveably coupled to the boom arm 122. However, the working tool 124 may be any working tool, forestry head, or forestry attachment known in the art, such as, for example, a felling head, harvesting head, log fork, grapple, or Waratah head, among others. The boom assembly 118 may extend from the main frame 108 along a working direction of the boom assembly 118. The working direction can also be described as a working direction of the boom 120. As described herein, control of the work implement 116 may relate to control of any one or more of the associated components (e.g., boom 120, boom arm 122, working tool 124).

As illustrated in FIGS. 1a and 1b, in some implementations the first and second ground engaging units 104, 106 may be tracked ground engaging units. The first tracked ground engaging unit 104 may include a first front idler 126, a first drive sprocket 130, and a first track chain 134 extending around the first front idler 126. Likewise, the second ground engaging unit 106 may include a second front idler 128, a second drive sprocket 132, and a second track chain 136 extending around the second front idler 128.

Each of the tracked ground engaging units 104, 106 may include a front idler 126, 128, a drive sprocket 130, 132, and a track chain 134, 136 extending around the respective front idler 126, 128 and the respective drive sprocket 130, 132. The travel motor of each tracked ground engaging unit 104, 106 drive its respective drive sprocket 128. Each tracked ground engaging unit 104, 106 has a forward traveling direction 132 defined from the drive sprocket 128 toward the front idler 126. The forward traveling direction 138 of the tracked ground engaging units 104, 106 also defines a forward traveling direction 138 of the undercarriage 102 and thus of the working machine 100.

An operator's cab 140 may be located on the main frame 108. The operator's cab 140 and the boom assembly 118 may both be mounted on the main frame 108 so that the operator's cab 140 faces in the working direction of the boom assembly 118. A control station 142 may be located in the operator's cab 140.

An engine 144 may also be mounted to the main frame 108 such that the engine 144 powers the working machine 100. In some implementations, the engine 144 maybe a diesel internal combustion engine. The engine 144 may also drive a hydraulic pump to provide hydraulic power to various operating systems of the working machine 100.

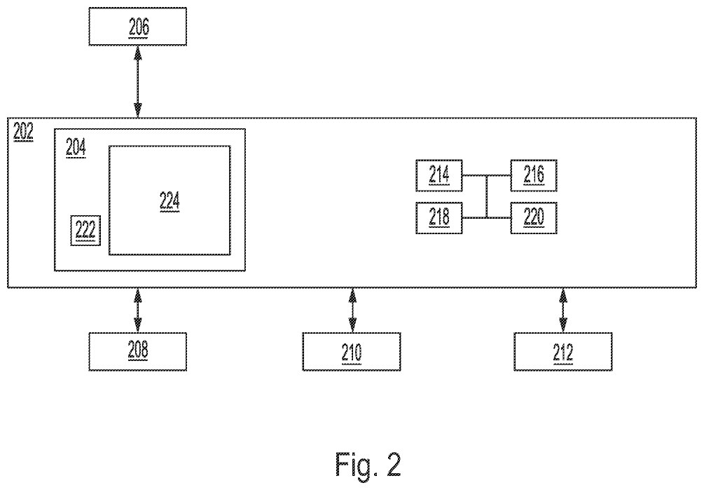

As schematically illustrated in FIG. 2, the self-propelled work machine 100 may include a control system with a controller 202. The controller 202 may be part of the machine control system of the work machine 100, or it may be a separate control module. The controller 202 may include a user interface 204 which may be mounted in the operator's cab 140 of the control station 142.

The controller 202 may be communicatively coupled to one or more sensors. The controller 202 may be configured to receive input signals or data from one or more sensors collectively defining a sensor system 206. The one or more sensors of the sensor system 206 may be discrete in nature, but signals representative of more than one input parameter may be provided from the same sensor, and the sensor system 206 may further refer to signals provided from the machine control system.

The controller 202 may be configured to produce outputs to the user interface 204 for display to an operator. The controller 202 may further, or in the alternative, be configured to generate control signals for controlling the operation of respective actuators, or signals for indirect control via immediate controls, associated with a machine steering control system 208, a machine implement control system 210, and an engine speed control system 212. The controller 202 may, for example, generate control signals for controlling the operation of various actuators, such as hydraulic motors or hydraulic piston-cylinder units, and electronic control signals from the controller 202 may actually be received by electro-hydraulic control valve associated with the actuators such that the electro-hydraulic control valves will control the flow of hydraulic fluid to and from the respective hydraulic actuators to control the actuation thereof in response to the control signal from the controller 202.

The controller 202 may include, or be associated with, a processor 214, a computer readable medium 216, a communication unit 218, data storage 220 such as, for example, a database network, and the aforementioned user interface 204 or a control panel 204 having a display 224. An input/output device 222, such as a keyboard, joystick, or other user interface tool is provided so that an operator may input instructions to the controller 202. It is understood that the controller 202 described herein may be a single controller having all of the described functionality, or it may include multiple controllers wherein the described functionality is distributed among the multiple controllers.

Various operations, steps, or algorithms as described in connection with the controller 202 may be embodied directly in hardware, in a computer program product such as a software module executed by the processor 214, or in a combination of the two. The computer program product can reside in RAM memory, flash memory, ROM memory, EPROM memory, EEPROM memory, registers, hard disk, a removable disk, or any other form of computer-readable medium 216 known in the art. An exemplary computer readable medium 216 can be coupled to the processor 214 such that the processor 214 may read information from, and write information to, the memory/storage medium 216. In the alternative, the medium 216 may be integral to the processor 214. The processor 214 and the medium 216 may reside in an application specific integrated circuit (ASIC). The ASIC may reside in a user terminal. In the alternative, the processor 214 and the medium 216 may reside as discrete components in a user terminal.

The term “processor” 214 as used herein may refer to at least general-purpose or specific-purpose processing devices and/or logic as may be understood by one of skill in the art, including, but not limited to, a microprocessor, a microcontroller, a state machine, and the like. A processor 214 can also be implemented as a combination of computing devices, e.g., a combination of a DSP and a microprocessor, a plurality of microprocessors, one or more microprocessors in conjunction with a DSP core, or any other such configuration.

The communication unit 218 may support or provide communications between the controller 202 and external systems or devices, and/or support or provide communication interfaced with respect to internal components of the work machine 100. The communications unit 218 may include wireless communication system components (e.g., via cellular modem, Wi-Fi, Bluetooth, or the like) and may include one or more wired communications terminals such as universal serial bus ports.

The data storage 220 may, unless otherwise stated, generally encompass hardware such as volatile or non-volatile storage devices, drives, memory, or other storage media as well as one or more databases residing thereon.

As illustrated in FIGS. 1a and 1b, the work machine 100 may be a forestry swing machine 146 and the working tool 124 may be a grapple 148 with a first protruding member herein called a first grapple arm 154, a second protruding member herein called a second grapple arm 156, and a third protruding member herein called a third grapple arm 158. The grapple arms 154, 156, 158 may move between an open position, a closed position, and any position therebetween. Generally, the grapple arms 154, 156, 158 may be in a closed position when material, such as logs, are picked up and moved. The grapple arms 154, 156, 158 may be generally in an open position when the material is being released or unloaded, or after material has been released and prior to picking up the material. While three grapple arms are discussed, an attachment with any number of grapple arms may be used. For example, as illustrated in FIG. 1b, there may be four grapple arms 154, 156, 158, 160. The grapple may also have more than four grapple arms.

In one example, the grapple 148 may be coupled to one or more sensors 150 and the grapple 148 may rotate about a grapple pivot axis 152. The one or more sensors 150 may detect the one or more characteristics and/or orientations of the grapple 148. For example, the one or more sensors 150 may detect the rotational position of one or more of the grapple arms 154, 156, 158 about the grapple pivot axis 152. The one or more sensors 150 may also detect the vertical position of the grapple 148 relative to the ground surface 114, referred to herein as grapple height. In some examples, the one or more sensors 150 may detect the position of the grapple 148 relative to the main frame 108 of the work machine 100, such as, for example, the horizontal distance the grapple 148 is located relative to the main frame 108. In another example, the one or more sensors 150 may be coupled to another part of the work machine, other than the grapple 148, and the one or more sensors 150 may detect one or more of the height or orientation of the grapple 148. In some examples, the one or more sensors 150 may sense whether the grapple 148 is in an open position or in a closed position. In other examples the one or more sensors 150 may detect whether the grapple is carrying a load or not carrying a load. The work machine 100 may also have one or more sensors 150 that can determine the position of the work machine 100 or the positions of one or more components of the work machine 100, thus the one or more sensors 150 may detect a position and a change in position of the work machine 100 or a change in position of one or more components of the work machine 100. In some examples, the sensor may have GPS capabilities and the GPS location of one or more of the grapple 148 or the work machine 100 may be detected. In some examples, the one or more sensors 150 may detect the positional orientation of the grapple 148, and the positional orientation may include one or more of the grapple 148 position relative to the ground surface 114, the grapple 148 position relative to the swing machine 146, or the GPS position of the grapple 148, the swing machine 146, or both the grapple 148 and the swing machine 146.

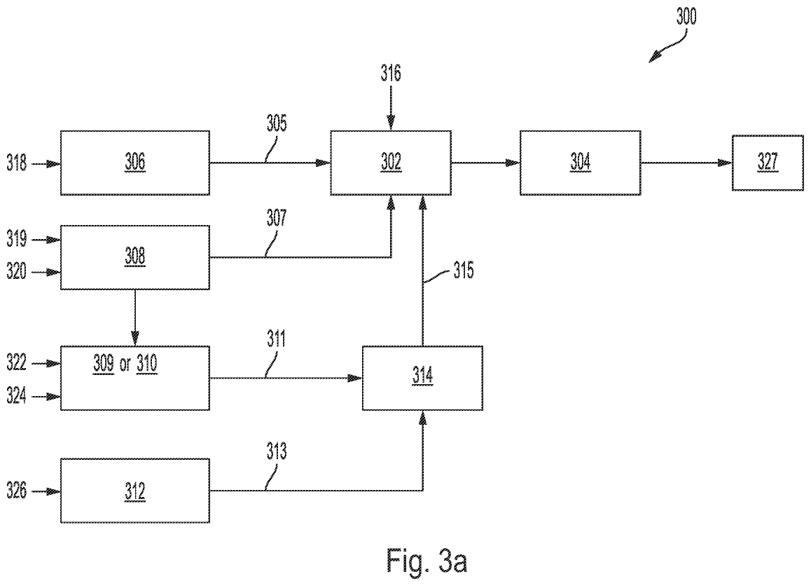

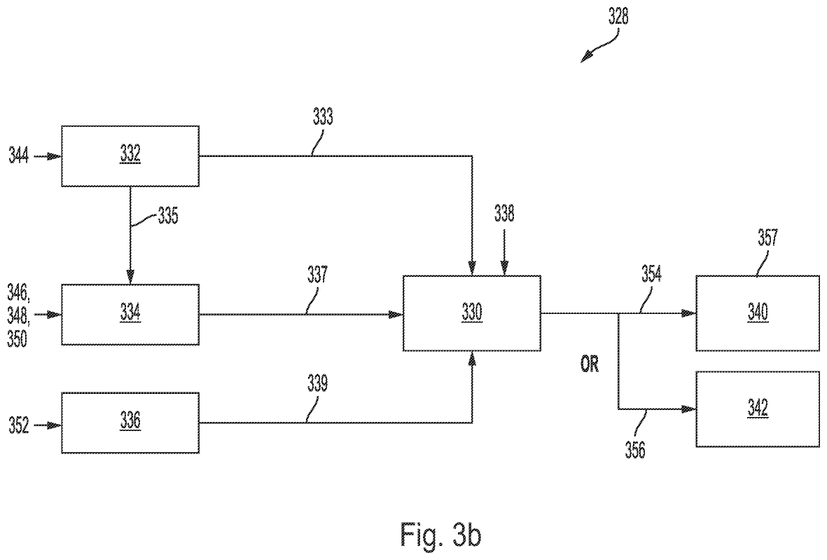

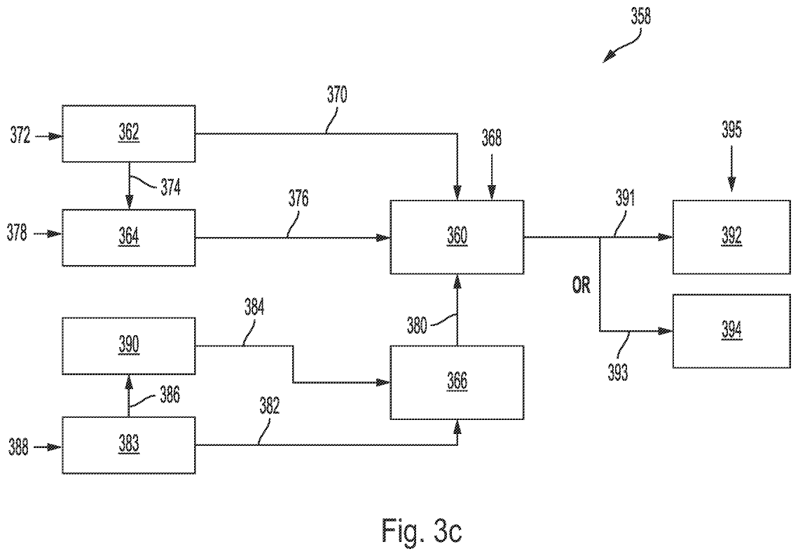

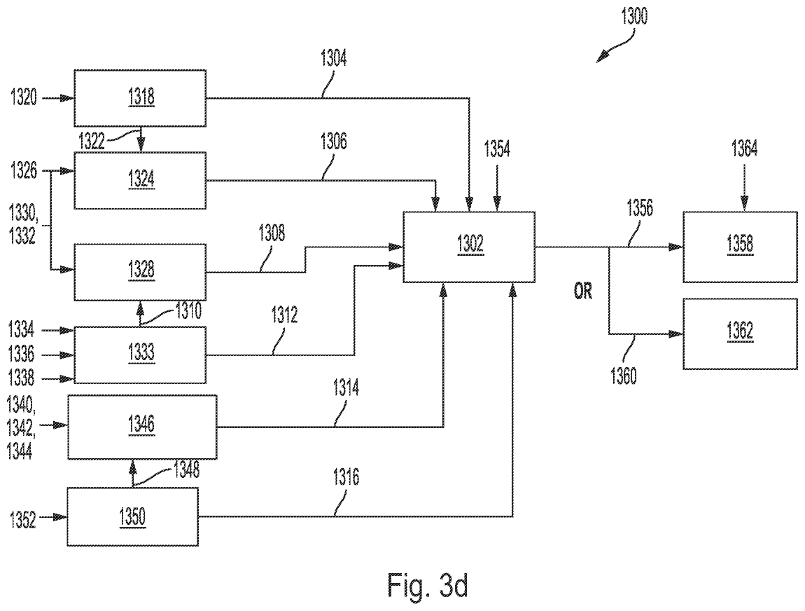

FIG. 3a illustrates a passive rotate orientation control system 300. As used herein, passive rotate orientation or passive control may refer to a semi-automatic mode, and active rotate orientation or active control may refer to an automatic mode. This system 300 may include a first comparator 302 coupled to a grapple rotary sensor 318, a record command 319, a function button 320, a second comparator 314, and a free swing joystick button 316. The second comparator 314 may additionally be coupled to the record command 319, the function button 320, a load sensing device 322, a grapple command 324, or a rotate command 326. In one example, the first comparator 302 may be a controller and the second comparator 314 may be a second controller.

Input may be communicated to the first comparator 302 and the first comparator 302 may communicate input to a free swing control 304. The input that may be communicated to the first comparator 302 may include one or more of a grapple rotate orientation 305, a set point 307, an operational cycle 311, whether or not a rotate command 326 is input to rotate function hydraulic 313, and an enable/disable signal 315.

The grapple rotary sensor 318 may be coupled to the swing machine 146. More specifically, the grapple rotary sensor 318 may be coupled to one or more of the grapple 148, the boom arm 122, or anywhere on the boom assembly 118. The grapple rotary sensor 318 may also be coupled to the main frame 108 of the swing machine 146. In some examples, the grapple rotary sensor 318 may be remote from the swing machine 146. In some examples, the system 300 may monitor a grapple position 306 via the grapple rotary sensor 318. More specifically, the grapple rotary sensor 318 may detect the grapple rotational orientation 305 about the grapple rotational axis 152 and may communicate this grapple rotational orientation 305 to the first comparator 302. In some examples, the grapple rotary sensor 318 may continuously communicate the grapple rotational orientation 305 to the first comparator 302. In other examples, the grapple rotary sensor 318 may periodically communicate the grapple rotational orientation 305 to the first comparator 302. In some examples, the grapple rotary sensor 318 may communicate the grapple rotational orientation 305 to the first comparator 302 based on a time variable, for example, every one second, two seconds, five seconds, or ten seconds. In other examples, the grapple rotary sensor 318 may communicate the grapple rotational orientation 305 to the first comparator 302 when the grapple 148 reaches a particular orientation, such as the recorded orientation of a log pile or a log truck. As used herein, the term log truck may include and be interchangeable with any log loading area, such as, for example, a log bunk 826 on a Forwarder 846 (see FIG. 8). The grapple rotary sensor 318 may be a position sensor, proximity sensor, motion sensor, image sensor, or any other sensor known in the art capable of detecting rotational orientation of one or more working tools 124.

The first comparator 302 may also be coupled to one or more of the function button 320 and a record command 319. In some examples, the system 300 may have a rotate orientation recording function 308, which may include the record command 319, the function button 320, and may record the set point 307. The input communicated to the rotate orientation recording function 308 may include one or more of a record command 319 and the command function button 320, and the rotate orientation recording function 308 may communicate the set point 307 to one or more of the first comparator 302, a swing direction function 309, and a load in grapple function 310. The function button 320 may be located on the control panel 204. In some examples, the function button is located on the input/output device 222, such as on the joystick. The operator may use the function button 320 to manually record the set point 307. More specifically, when the operator selects or presses the function button 320, the function button 320 may communicate to the controller that a function button command is actuated, and the controller may record the set point of the grapple 148. In some examples, the controller may communicate that the function button 320 was pressed or selected to the first comparator 302, and the first comparator 302 may associate a set point with the grapple rotate position 305 at the time the function button command was pressed or selected. In one example, the controller may record the set point of the grapple 148 based on input from a sensor, such as, for example, the grapple rotary sensor 318.

The record command 319 may be communicated to the system 300 based on the status of the grapple 148. In one example, the controller may command the system 300 to record the set point 307 via the record command 319. When the grapple 148 transitions from an open position to a closed position the record command 319 may be communicated to the system 300. Similarly, when the grapple 148 transitions from the closed position to the open position the recorded command 319 may be communicated to the system 300. The rotational orientation of the grapple 148 at the time the record command 319 is communicated may be the set point 307 or may be associated with the set point 307. In one implementation the grapple rotary sensor 318 may communicate the grapple rotate orientation 305 to the rotate orientation recording function 308. In this implementation, when one or more of the function button 320 and the record command 319 communicate that a command is input to the system 300, the set point 307 may be communicated to one or more of the first comparator 302, the swing direction function 309, or the load in grapple function 310.

Still referring to FIG. 3a, the first comparator 302 may additionally be coupled to the second comparator 314. The second comparator 314 may be coupled to, a load sensing device 322, the grapple command 324, the rotate command 326, and the function button 320. The second comparator 314 may communicate the enable/disable signal 315 to the first comparator 302, and the enable/disable signal 315 may communicate to the first comparator 302 to enable or disable the free swing mode.

In some implementations, the system 300 may include one or more of a swing direction function 309 or a load in grapple function 310. A set point 307 may be communicated to one or more of the swing direction function 309 or the load in grapple function 310. In some examples, the system 300 may not have a set point 307 and one or more of the swing direction function 309 or load in grapple function 310 may be disabled. In some implementations, the set point 307 may be communicated to the swing direction function 309 or load in grapple function 310, and this communication of the set point 307 may enable one or more of the swing direction function 309 or the load in grapple function 310. The swing direction function 309 may communicate the operational cycle 311 to the second comparator 314. In one example, the load in grapple function 310 may communicate the operational cycle 311 to the second comparator 314.

The swing direction function 309 may detect and communicate the swing direction of the swing machine 146. The swing direction function 309 may include a sensor to detect whether the swing machine 146 rotates about the pivot axis 112, also referred to herein as the swing direction. In some implementations, the sensor may detect the swing direction. In one example the sensor may be positioned on the grapple 148. In other examples, the sensor may be positioned on the main frame 108 or the boom assembly 118 of the swing machine 146. In other examples, the sensor may be remote relative to the swing machine 146. While the swing direction may be detected via one or more sensors, it may also be determined by one or more of the load sensing device 322, the grapple command 324, or the grapple 148 open or closed status.

The system 300 may include the swing direction to determine whether the swing machine 146 is moving from a log pile to a log truck, or from a log truck to a log pile. While the term log truck is used herein, a log truck may also refer to any log loading area. In one example, the swing machine 146 may move from a log pile to a log truck and the system 300 may move the grapple 148 to a first grapple orientation. In some examples, the swing machine 146 may move from a log truck to a log pile and the system 300 may move the grapple 148 to a second grapple orientation.

The load in grapple function 310 may communicate that there is a load detected in the grapple 148 or that no load is detected in the grapple 148. To determine whether or not a load is detected in the grapple 148, the load in grapple function 310 may include one or more of the load sensing device 322, grapple command 324, or the status of the grapple 148. One or more of the swing direction function 309 or the load in grapple function 310 may communicate the operational cycle 313 to the second comparator 314.

The operational cycle 311 may include an instruction. The operational cycle 311 may communicate the instruction to the second comparator 314 based on input which may include the load sensing device 322, the status of the grapple 148, or the grapple command 324. The status of the grapple 148 may be determined by one or more of the load sensing device 322 or a grapple command 324. The load sensing device 322 may be a sensor that detects pressure. In one example, the load sensing device 322 may be a pressure sensor. The load sensing device 322 may be located in or on the grapple 148 and may detect whether there is a load in the grapple 148. In one example, when the grapple 148 grabs a load the load may press or contact the pressure sensor. In some examples, the load sense device 322 may include a device that performs a visual analysis of the grapple 148, such as a camera that visually detects whether the grapple 148 has a load. In these examples, the load sense device 322 may be coupled to the grapple 148 or to another part of the swing machine 146. In some examples, the load sensing device 322 may be a position sensor, proximity sensor, motion sensor, image sensor, or any other device known in the art capable of detecting whether or not the grapple 148 is carrying a load.

In one example, the load sensing device 322 may detect a load in the grapple 148 and the system 300 may determine that the grapple 148 is carrying a load. When the grapple 148 is carrying a load, an instruction may be communicated to the second comparator 314 to return to truck. In another example, the load sensing device 322 may not detect a load in the grapple 148. Based on this, the system 300 may determine that the grapple 148 is not carrying a load. When the grapple 148 is not carrying a load, an instruction may be communicated to the second comparator 314 to return to the log pile.

The operational cycle 311 may also be determined based on whether a grapple command 324 is communicated or not. The grapple command 324 may communicate to one or more of the swing direction function 309 or load in grapple function 310 whether an open or close command was sent to the grapple 148. In some examples, the controller may be used to determine whether a grapple command 324 was communicated to the grapple 148. In one implementation, the system 300 may determine that a grapple close command 324 was sent to the grapple 148, and this may indicate that the grapple 148 grabbed material. In this implementation, a return to truck instruction may be communicated to the second comparator 314. In another implementation, the system 300 may determine that a grapple open command 324 was sent to the grapple 148. This may indicate that the grapple 148 dropped material and a return to log pile instruction may be communicated to the second comparator 314. In some examples, when the grapple command 324 is sent to the grapple 148 it is sent via the controller, and the controller may communicate the grapple command 324 to the swing direction function 309 or the load in grapple function 310. The controller may communicate when the system 300 receives a record command 319, a grapple command 324, or a rotate command 326.

In some implementations, the operational cycle 311 may be determined based on the status of the grapple 148. In one example, the grapple 148 may move from an open position to a closed position and this may indicate that the grapple 148 grabbed material. In this example, a return to truck instruction may be communicated to the second comparator 314. In one example, the grapple 148 may move from the closed position to the open position, and this may indicate that the grapple dropped material. In this example, a return to log pile instruction may be communicated to the second comparator 314.

The system may also include rotate function hydraulics 312. The rotate function hydraulics 312 may detect when a rotate command is input into the system 300 instructing the grapple 148 to rotate. The rotate function hydraulics 312 may communicate to the second comparator 314 that a rotate command 326 was communicated to the system 300. In some examples, the rotate command hydraulics 312 may communicate that a rotate command 326 was not communicated to the system 300. The rotate function hydraulics 312 may include a hydraulic valve which may rotate the grapple 148. The rotate function hydraulics 312 may include a rotate command 326, wherein the rotate function hydraulics 312 may rotate the grapple 148. In some implementations, the input/output device 222, such as a button on a joystick or on a keyboard, may send the rotate command 326.

The second comparator 314 may communicate an enable or disable signal 315 to the first comparator 302. The enable signal may instruct the first comparator 302 to activate the free swing mode for the grapple 148, and the disable signal may instruct the first comparator 302 to deactivate free swing mode for the grapple 148. When the grapple 148 is in free swing mode, the grapple 148 may rotate about the grapple pivot axis 152 due to momentary activation of the rotate function without being rotated by the swing machine 146 and without being prevented from rotating by the swing machine 146. The second comparator 314 may have an algorithm that includes a variable for one or more of the operational cycle 311, whether the rotate function hydraulics 312 is commanded or not commanded 313 to rotate, and the set point 307. The second comparator 314 may then determine whether the grapple 148 should be in free swing mode, and the second comparator 314 may communicate an enable or disable signal 315 to the first comparator 302.

The passive rotate orientation control system 300 may also include the free swing joystick button 316. The free swing joystick button 316 may be located in the operator's cab 140 of the swing machine 146. The operator may press the free swing joystick button 316 to enable or disable the free swing function. By pressing the free swing joystick button 316, the operator may communicate to the system 300 to stop the automatic or semi-automatic loading mode and move to a manual loading mode. In other words, by pressing the free swing joystick button 316 the operator may toggle between one or more of the manual mode, the semi-automatic mode, and automatic mode. In some examples, the free swing joystick button 316 may supersede other inputs from the system 300, such that the operator may override the other inputs into the system 300.

The first comparator 302 may have an algorithm that may include a variable for one or more of the grapple rotate orientation 305, the set point 307, the enable or disable signal 315, and the input from the free swing joystick button 316. In some examples, the result of the algorithm may be whether the grapple 148 or another working tool 124 has reached a desired orientation. The first comparator 302 may communicate this determination that the grapple 148 reached the desired orientation to the free swing control 304, or it may communicate a determination that the grapple 148 has not reached the desired orientation to the free swing control 304. In some examples, the output from the first comparator 302 may be communicated as a flag to the free swing control 304. The flag may be true if the desired grapple orientation is reached, and the flag may be false if the desired grapple orientation has not been reached.

In the passive rotate orientation control system 300, the free swing control 304 may enable or disable the free swing function 327. In one example, the grapple 148 may reach the recorded orientation and the free swing control 304 may disable the free swing function 327. The free swing function may be disabled 327 by deactivating an on/off hydraulic valve, or the free swing function may be disabled 327 gradually by closing a proportional hydraulic valve for smooth operation. In some examples, an actuator may be coupled to the grapple 148 and may be communicatively coupled to one or more controllers. In these examples, the actuator may operate in one or more of an engaged mode or a disengaged mode. When operating in the engaged mode, the actuator may deactivate the free swing mode of the grapple 148. When the actuator is operating in the disengaged mode, it activates free swing mode. In some examples, the grapple 148 may not reach the desired grapple orientation and the free swing control 304 may enable the free swing function 327. The free swing function may be enabled 327 by activating the hydraulic valve.

FIG. 3b illustrates a basic control system for an active and passive rotate orientation control system 328. The control system 328 may determine the desired grapple orientation 330 based on one or more inputs, and once the desired grapple orientation is determined 330 the control system 328 may activate or deactivate one or more controls related to the grapple 148. The input to the control system 328 may include a present grapple rotate orientation 333, a recorded grapple rotate orientation 337, a drop/carry position 339, and/or a grapple free swing mode on/off button 338.

The present grapple rotate orientation 333 may be detected via grapple rotate orientation monitoring 332. More specifically, grapple rotate orientation monitoring 332 may be performed by a grapple rotate orientation sensor 344 that detects the grapple rotate orientation. The sensor 344 may be located on the grapple 148, the boom assembly 118, or any other part of the swing machine 146. The sensor 344 may detect one or more of a recorded grapple rotate orientation 335 and a present grapple rotate orientation 333. In one example, after the present grapple rotate orientation 333 is detected it may be used as input to determine the desired grapple orientation 330. In some implementations, the recorded grapple rotate orientation 335 may be stored via rotate orientation storage 334.

Another input the system 328 may include to determine the desired grapple orientation 330 is a rotate orientation set point 337, which may be associated with a drop/carry position of the grapple 148. In one example, a record orientation command 346 may record a grapple rotate orientation set point 337. The set point 337 may be stored in the rotate orientation storage 334. In some examples, the grapple rotate orientation set point 337 may be recorded using an operator button 348, and this grapple rotate orientation set point 337 may be stored in the rotate orientation storage 334. The recorded grapple rotate orientation set point 337 may also be recorded when the grapple 148 is opened or closed 350. In one example, when the grapple 148 is opened 350 a recorded rotate orientation set point 337 may be recorded and associated with a drop position. In another example, when the grapple 148 is closed 350 a recorded rotate orientation set point 337 may be recorded and associated with a carry position. The set points 337 recorded when the grapple 148 is opened or closed 350 may be stored in the rotate orientation storage 334. In one example, after the recorded rotate orientation set point 337 is detected it may be used as a variable by the system 328 to determine the desired grapple orientation 330.

Another input the control system 328 may include to determine the desired grapple orientation 330. The desired grapple orientation 330 is the boom position when the grapple 148 is in a drop/carry position 339. To determine the drop/carry position 339, the system 328 may identify the boom position 336 when the grapple 148 is in the drop/carry position 339. The boom position may be identified 336 via the grapple open/close state 352. The grapple open/close state 352 may specify whether the grapple 148 is open or closed. The status of whether the grapple 148 is opened or closed may be determined by the last active command provided to the grapple 148. For example, if the last active command communicated to the grapple 148 is a close command, the grapple open/close state 352 may be closed. If the last active command communicated to the grapple 148 is an open command, then the grapple open/close state 352 may be open. The identification of the boom position 336 when the grapple 148 is opened and when the grapple 148 is closed may be recorded. The system 328 may include the boom position identification 336 at the time the last active open or close command was given to determine the grapple 148 drop/carry position 339. In one example, the grapple drop/carry position may be determined relative to the swing machine 146. The grapple drop/carry position may also be determined relative to one or more log piles, log trucks, or another location.

Still referring to FIG. 3b, the system 328 may include the grapple free swing mode on/off button 338, also referred to as a free swing mode button. In one example, the grapple free swing mode on/off button 338 may be located within the operator's cab 140. In other examples, the grapple free swing mode on/off button 338 may be located remote relative to the swing machine 146. In some examples, the grapple free swing mode on/off button 338 may be located on the input/output device 222, such as, for example, on the joystick or keyboard. The grapple free swing mode on/off button 338 may enable or disable free swing function control 340. In some implementations, the button 338 may be selected by an operator. In some examples, the free swing mode on/off button 338 may supersede other inputs of the system 328. In one example, the operator may select the free swing on/off button 338 and instruct the system 328 to turn on the free swing mode. The system 328 may then turn the free swing mode on even if other inputs to the system 328 indicate that free swing mode should be off. In another example, the operator may select the free swing mode on/off button 338 and instruct the system 328 to turn the free swing mode off. The system 328 may then turn the free swing mode off, even if other inputs to the system 328 indicate that free swing mode should be on. The free swing mode on/off button 338 may be one way for the operator to manually override or otherwise control whether the grapple 148 is in free swing mode or not in free swing mode.

The system 328 may determine the desired grapple orientation 330 via an algorithm, which may include one or more inputs. The inputs to the algorithm may include one or more of the present grapple rotate orientation 333, the recorded rotate orientation set point 337, the drop/carry position 339, and the grapple free swing mode on/off button 338. In one example, the control system 328 may apply the passive control mode, the control system 328 may determine that the grapple 148 is in the desired grapple orientation 330, and the system 328 may communicate a deactivate free swing function 354 to the grapple free swing function control 340. Deactivating the free swing function 354 may prevent the grapple 148 from rotating out of the desired orientation. In another example, the control system 328 may apply the active control mode, the control system 328 may determine the grapple 148 is in the desired grapple orientation 330, and the system 328 may communicate a turn off rotate function 356 to the grapple rotate function control 342. The grapple rotate function control 342 may include one or more hydraulic valves that may rotate the grapple 148 or prevent the grapple 148 from rotating. When the turn off rotate function 356 is communicated to the grapple rotate function control 342, the control 342 may stop the rotation of the grapple 148 and prevent the grapple from rotating.

In some examples, an actuator may be coupled to the grapple 148 and may be communicatively coupled to one or more controllers. In these examples, the actuator may operate in one or more of an engaged mode or a disengaged mode. When operating in the engaged mode, the actuator may deactivate the free swing mode of the grapple 148, may rotate the grapple 148, or may prevent the grapple 148 from rotating. When the actuator is operating in the disengaged mode, it may activate free swing mode.

In some examples, the control system 328 may include a controller (not shown) and the controller may communicate the inputs and determine the desired grapple orientation 330 via the algorithm. Still referring to these examples, if the system 328 is applying the passive control mode, the controller may deactivate the free swing function 354 when the grapple 148 is in the desired grapple orientation. Alternatively, if the system 328 is applying the active control mode, the controller may communicate a turn off rotate function 356 to the grapple rotate function control 342. After receiving this command, the grapple rotate function control 342 may turn off the grapple rotate function, and then the grapple 148 may be prevented from rotating from the desired grapple orientation.

Input from a grapple free swing mode on/off button 357 may also be communicated to the grapple free swing function control 340. In one example, the grapple free swing mode on/off button 357 may be located within the operator's cab 140. In other examples, the grapple free swing mode on/off button 357 may be located remote relative to the swing machine 146. In some examples, the grapple free swing mode on/off button 357 may be located on the input/output device 222, such as, for example, on the joystick or keyboard. The grapple free swing mode on/off button 357 may enable or disable the grapple free swing function control 340. In some examples, the button 357 may be selected by an operator.

Similar to FIG. 3b, FIG. 3c is an illustration of a control system for the active and passive rotate orientation control system 358. The control system 358 of FIG. 3c may include additional inputs or variables compared to the control system 328 of FIG. 3b. Similar to the control system 328 of FIG. 3b, the control system of FIG. 3c may determine the desired grapple orientation 360 based on one or more inputs. Once the desired grapple orientation is determined 360 the control system 358 may activate or deactivate one or more controls related to the grapple 148. The inputs to the control system of FIG. 3c may include present grapple rotate orientation 370, rotate orientation set point 376, recorded swing orientation 384, present swing orientation 382, and the boom position at a grapple drop/carry position 380.

The system 358 may determine the present grapple rotate orientation 370 via a grapple rotate orientation monitoring system 362. The grapple rotate orientation monitoring system 362 may include a grapple rotate sensor 372 that is configured to detect the grapple orientation. In some implementations, the sensor 372 may detect the present grapple rotate orientation 370. The present grapple rotate orientation 370 may then be communicated as input to determine the desired grapple orientation 360. The grapple rotate orientation monitoring system 332 may also detect the rotate orientation at the time of recording 374. This recorded rotate orientation 374 may be communicated to the rotate orientation storage 364.

Also similar to the control system 328 of FIG. 3b, the control system 358 of FIG. 3c may include the rotate orientation set point 376 as input to determine the desired grapple orientation 360. This set point 376 may be detected by the grapple rotate orientation monitoring system 362 and may be stored in the rotate orientation storage. This set point 376 may also be detected by a record orientation command. In other words, the system 358 may receive a record orientation command for a grapple 148 drop/carry position, and the grapple orientation when this command 378 is input may be stored as a set point 376, communicated as an input to determine the desired grapple orientation 360, or both.

Another input the control system 358 may include to determine the desired grapple orientation 360 is the position of the boom 120 when the grapple 148 moves between drop/carry positions. Drop/carry positions 380 may include the position of the boom 120 when the grapple moves from the drop to carry position or from a carry to drop position. In some examples, the system 358 may detect one or more of a present swing orientation 382 and the recorded swing orientation 384 for the boom 120 when the grapple 148 moves between drop and carry positions. The present swing orientation 382 may include one or more of the swing orientation of the swing machine 146 or the swing orientation of the boom 120. Based on one or more of the recorded or present swing orientations, 382, 384 the system 358 may identify the boom position 366 and may determine boom 120 position at the drop/carry position 380.

The present swing orientation 382 may be detected by machine/boom swing orientation monitoring 383. More specifically, a swing orientation sensor 388 may detect the present swing orientation 382 which may include one or more of the present machine swing orientation and the present boom swing orientation. The system 358 may include the present swing orientation 382 as an input to identify the boom position 366.

The swing orientation sensor 388 may also detect the recorded swing orientation 386, which may include one or more of the recorded boom swing orientation and the recorded machine swing orientation. The recorded swing orientation 386 may be detected by the swing orientation sensor 388 and stored in the machine boom swing storage, whereas the recorded swing orientation 384 may be any of the recorded swing orientations related to drop/carry positions of the grapple stored in the machine boom swing storage 390. In some examples, the system 358 may include the recorded swing orientation 384 that is stored in the storage 390 as an input to identify the boom position 366 associated with the grapple 185 drop/carry position 380.

Another input the system 358 may include to determine the desired grapple orientation 360 is the grapple free swing mode on/off button 368. This grapple free swing mode on/off button 368 may be located within the operator's cab 140, or may be located remote relative to the swing machine 146. In some examples, the grapple free swing mode on/off button 368 may be located on the input/output device 222 such as, for example, on the joystick or keyboard. The grapple free swing mode on/off button 368 may enable or disable the free swing function control. In some implementations, the button 368 may be selected by an operator.

Similar to system 328, this system 358 may include the grapple free swing mode on/off button 368 as an input to determine the desired grapple orientation 360. This button 368 may be located within the operator's cab 140. In some examples, the grapple free swing mode on/off button 368 may be located remote relative to the swing machine 146. The grapple free swing mode on/off button 368 may enable or disable the free swing function control. In some implementations this button 368 may be selected by an operator. Also similar to system 328, this system 358 may include an algorithm with one or more inputs, and the algorithm may determine the desired grapple orientation 360. The inputs to the algorithm may include one or more of the present grapple rotate orientation 370, the recorded rotate orientation set point 376, the drop/carry position 380, and the grapple free swing mode on/off button 368.

In some implementations, the control system 358 may apply the passive control mode, and after the control system 358 determines that the grapple 148 is in the desired grapple orientation 360 the system 358 may communicate a deactivate free swing function 391 to the grapple free swing function control 392. Deactivating the free swing function 392 may maintain the grapple 148 in the desired grapple orientation 360.

In another example, the control system 358 may apply the active control mode, and after the control system 358 determines the grapple 148 is in the desired grapple orientation the system 358 may communicate a turn off rotate function 393 to the grapple rotate function control 394. The grapple rotate function control 394 may include one or more hydraulic valves that may rotate the grapple 148 or prevent the grapple 148 from rotating. When the turn off rotate function 393 is communicated to the grapple rotate function control 394, the control system 358 may stop the rotation of the grapple 148 and maintain the grapple 148 in the desired grapple orientation.

Input from a grapple free swing mode on/off button 395 may also be communicated to the grapple free swing function control 392. In one example, the grapple free swing mode on/off button 395 may be located within the operator's cab 140. In other examples, the grapple free swing mode on/off button 395 may be located remote relative to the swing machine 146. In some examples, the grapple free swing mode on/off button 395 may be located on the input/output device 222, such as, for example, on the joystick or keyboard. The grapple free swing mode on/off button 395 may enable or disable the grapple free swing function control 392. In some examples, the button 338 may be selected by an operator.

Referring now to FIG. 3d, an active/passive rotate orientation control system 1300 is illustrated for a grapple orientation adjustment per a boom position displacement. Similar to system 328 and system 358 described above, this system 1300 may determine the desired grapple orientation 1302 using one or more inputs. The inputs may include a present grapple rotate orientation 1304, a recorded rotate orientation set point 1306, a recorded distance 1308, a distance from machine at the time of recording 1310, the present distance from machine 1312, the recorded swing orientation 1314, the present swing orientation and speed 1316, and a grapple free swing mode on/off button 1354. Once the desired grapple orientation is determined 1302, the control system 1300 may activate or deactivate one or more controls related to the grapple 148, such as, for example, a free swing function control 1358 and a grapple rotate function control 1362.

The system 1300 may determine the present grapple rotate orientation 1304 via grapple rotate orientation monitoring 1318. The grapple rotate orientation monitoring 1318 may include a grapple rotate sensor 1320. This sensor 1320 may detect the grapple orientation. In some implementations, the grapple rotate sensor 1320 may detect the present grapple orientation 1304. The system 1300 may include the present grapple rotate orientation 1304 as input to determine the desired grapple orientation 1302. In some implementations the sensor 1320 may detect a recorded rotate orientation 1322. The system 1300 may store the recorded rotate orientation 1322 in the rotate orientation storage 1324.

Another input the system 1300 may to determine the desired grapple orientation 1302 is the recorded rotate orientation set point 1306. In one example the recorded orientation 1322 may be stored in the rotate orientation storage 1324 after being sensed from the grapple rotary sensor 1320, and the system 1300 may include the recorded rotate orientation set point 1306 as an input to determine the desired grapple orientation 1302. The recorded swing orientation 1322 may be detected by the grapple rotary sensor 1320 and stored in the rotate orientation storage 1324, whereas the recorded swing orientation 1306 may be any of the recorded swing orientations related to drop/carry positions of the grapple 148 stored in the rotate orientation storage 1324. In some examples, a record position and orientations command 1326 may be input to the system 1300. Upon receiving the command 1326, the system may record one or more of the grapple 148 position and orientation, and this position or orientation may be associated with a carry/drop position. In some implementations, the record positions and orientations command 1326 may be stored in the rotate orientation storage 1324. In another example, the record positions and orientations command may be stored in boom position storage 1328.

The recorded rotate orientation set point 1306 may also be recorded via a button 1330. In one example, the operator may select the button 1330 and the system 1300 may record the rotate orientation set point 1306. In this example, the set point 1306 may be stored in one or more of the rotate orientation storage 1324 or the boom position storage 1328.

In some implementations, the recorded rotate orientation set point 1306 may be recorded based on the status of the grapple 1332. In these implementations, the grapple 148 may move from the open position to the closed position, and the system 1300 may record a recorded rotate orientation set point 1306 associated with the grapple carry position. The grapple 148 may also move from a closed position to an open position, and the recorded rotate orientation set point 1306 may be recorded that is associated with the grapple 148 drop position. The recorded rotate orientation set point 1306 may be stored in one or more of the rotate orientation storage 1324 or the boom position storage 1328.

In some examples, the set point 1306 may be detected by the grapple rotate orientation monitoring system 1318 and stored in the rotate orientation storage 1324. In one example, the recorded rotate orientation set point 1306 may be communicated to the storage 1324 via a record positions and orientations command 1326. The record positions and orientations command 1326 may record one or more of a position and orientation of the grapple 148 that may correspond to a drop position, the carry position, or both the drop and carry position. The set point 1306 may include the recorded grapple position, grapple orientation, or both the grapple position and the grapple orientation.

The recorded distance 1308 may be another input the system 1300 may include to determine the desired grapple orientation 1302. The recorded distance 1308 may include the distance the boom 120 is positioned relative to the swing machine 146. In some examples, the recorded distance 1308 may be detected by one or more of the recorded positions and orientations command 1326, the button 1330, or grapple open/close status 1332 and may be stored in the boom position storage 1328. In some examples, the record positions and orientations command 1326, button 1330, and grapple open/close status 1332 may detect one or more of the recorded distance 1308 and the recorded rotate orientation set point 1306.

The recorded distance from machine 1310 may be stored in the boom position storage 1328. The recorded swing orientation 1310 may be detected by one or more of a boom position sensor 1334, arm position sensor 1336, and arm extension sensor 1338 and stored in the boom position storage 1328, whereas the recorded distance 1308 may be any of the recorded swing orientations related to drop/carry positions of the grapple 148 stored in the boom position storage 1328. The recorded distance from machine 1310 may be monitored via boom position monitoring 1333. The boom position sensor 1334, arm position sensor 1336, and arm extension position sensor 1338 may be one or more of a position sensor, proximity sensor, pressure sensor, motion sensor, image sensor, GPS sensor, or any other device known in the art capable of detecting a change in boom 120 distance. In some examples, the system 1300 may include more than one boom position sensor 1334, arm position sensor 1336, and/or arm extension position sensor 1338.

The present distance from machine 1312 may also be detected via one or more of the boom position sensor 1334, the arm position sensor 1336, and the arm extension position sensor 1338. In one example, the boom position sensor 1334 may detect the position of the boom 120 relative to the swing machine 146, the arm position sensor 1336 may detect the position of the boom arm 122 relative to the swing machine 146, and the arm extension position sensor 1338 may detect the distance the boom arm 122 moves relative to the swing machine 146. In this example, one or more of these positions detected by the boom position sensor 1334, arm position sensor 1336, and arm extension position sensor 1338 may be used as inputs to determine a present distance from machine 1312. After the present distance from machine 1312 is detected or determined, the system 1300 may include the present distance from machine 1312 to determine the desired grapple orientation 1302. In some examples, these position sensors 1334, 1336, 1338 may continuously monitor the boom positions. In other examples, the system 1300 may limit when the position sensors 1334, 1336, 1338 may monitor the boom positions. In other examples, these position sensors 1334, 1336, 1338 may periodically monitor the boom positions.

The boom position sensor 1334 may be a position sensor that detects the boom position. In one example, the boom position sensor 1334 may be located on the swing machine 146 and may detect the boom position relative to the swing machine 146. In other examples, the boom position sensor 1334 may be located on the boom 120. In some examples, the boom position sensor 1334 may detect the boom position relative to a coordinate system, such as, for example, longitude and latitude or GPS coordinates. In some examples, the boom position sensor 1334 may detect a horizontal distance the boom 120 has moved. In other words, when the boom 118 is lowered the boom assembly may pivot, thereby when the boom 120 is in a lowered position it may extend more in a horizontal direction relative to when the boom 120 is not in a lowered position. In one example, the boom position sensor 1334 may detect the boom position relative to one or more of the swing machine 146 and a prior boom position.

The boom arm position sensor 1336 may be a position sensor that detects position of the boom arm 122. In one implementation, the boom arm position sensor 1336 may be located on the swing machine 146 and may detect the position of the boom arm 122 relative to the swing machine 146. In other examples, the boom arm position sensor 1336 may be located directly on the boom arm 122. In some examples, the boom arm position sensor 1336 may detect the boom arm 122 position relative to a coordinate system, such as, for example, longitude and latitude or GPS coordinates. In some examples, the boom arm position sensor 1336 may detect the horizontal displacement of the boom arm 122 relative to a prior position of the boom arm 122. In one example, the boom arm position sensor 1336 may detect the horizontal displacement of the boom arm 122 relative to the swing machine 146.

The boom arm extension position sensor 1338 may be a position sensor that detects the extension of the boom arm 122. In some examples, the boom arm 122 may extend telescopically, wherein one portion of the boom arm 122 extends or “slides out” relative to another portion of the boom arm 122 thereby lengthening the boom arm 122. The boom arm 122 may also retract telescopically, wherein one portion of the boom arm 122 retracts or “slides inwardly” relative to another portion of the boom arm 122 thereby shortening the length of the boom arm 122. In one implementation, the boom arm extension position sensor 1338 may be located on the swing machine 146. In some implementations, this sensor may be positioned on one or more of the extendable portion of the boom arm 122 and the non-extendable portion of the boom arm 122. In some examples, the boom arm extension position sensor 1338 may detect the boom arm 1222 position relative to the coordinate system. In other examples, the boom arm extension position sensor 1338 may detect the amount of extension the boom arm 122 extend relative to the non-extension section of the boom arm 122. In other examples, the boom arm extension position sensor 1338 may detect the amount of extension the boom arm extends relative to the swing machine 146.

In some implementations, one or more of the present distance from machine 1312 and recorded distance from machine 1310 may be detected by more than one sensor. The more than one sensor may include one or more of a boom position sensor 1334, arm position sensor 1336, arm extension position sensor 1338, or another sensor. In other implementations, one or more of the present distance from machine 1312 and recorded distance from machine 1310 may be detected by one sensor.

To determine the desired grapple orientation 1302, the system 1300 may also include the recorded swing orientation 1314 for grapple 148 drop/carry positions as an input. The recorded swing orientation 1314 may be detected by one or more of a record command for drop/carry position 1340, an operator button 1342, or the grapple open/close status 1344. In one example, the recorded swing orientation 1314 may be detected by one or more of the record command for carry/drop position 1340, the operator button 1342, and the grapple open/close status and the recorded swing orientation 1314 may be stored in the boom/machine swing orientation storage 1346. In some examples, the swing orientation sensor 1344 may detect the swing orientation at the time of recording 1348, and the swing orientation at the time of recording 1348 may be stored in the boom machine/swing orientation storage 1346, included as an input to determine the desired grapple orientation 1302, or both.

The system 1300 may also include the present swing orientation and speed 1316 for grapple 148 drop/carry positions to determine the desired grapple orientation 1302. The system 1300 may perform boom/machine swing orientation monitoring 1350 by using a swing orientation sensor 1352. The swing orientation sensor 1352 may detect one or more of the present swing orientation and speed 1316, the swing orientation at the time of recording 1348, and the recorded swing speed. In some examples, the swing orientation sensor 1352 may be located on the boom 120. In one example, the swing orientation sensor 1352 may be located on the swing machine 146. In some examples, there may be more than one swing orientation sensor 1352. In an example, there may be one or more swing orientation sensors 1352 positioned on the boom 120 and one or more swing orientation sensors 1352 positioned on the swing machine 146.

The system may also include a grapple free swing mode on/off button 1354. This button 1354 may be an input used by the system 1300 to determine the desired grapple orientation 1302. This button 1354 may be located within the operator's cab 140. In some examples, the grapple free swing mode on/off button 1354 may be located remote relative to the swing machine 146. The grapple free swing mode on/off button 1354 may enable or disable the free swing function control. In some implementations this button 1354 may be selected by an operator.

This system 1300 may also include an algorithm with one or more inputs, and the algorithm may determine the desired grapple orientation 1302. The inputs to the algorithm may include one or more of the present grapple rotate orientation 1304, the recorded rotate orientation point 1306, the recorded distance 1308 of the boom 120, the present distance from machine 1312 of the boom 120, the recorded swing orientation 1314 of the boom 120 or swing machine 146, and the present swing orientation and speed 1316 of the boom 120 or swing machine 146.

In some implementations, the system 1300 may apply the passive control mode, and after the grapple 148 is in the desired grapple orientation 1302, the system 1300 may communicate a deactivate free swing function 1356 to the grapple free swing function control 1358. Deactivating the free swing function 1356 may prevent the grapple 148 from rotating out of the desired grapple orientation 1302.

In another example, the system 1300 may apply the active control mode, and after the grapple 148 is in the desired grapple orientation the system 1300 may communicate a turn off rotate function 1360 to the grapple rotate function control 1362. The grapple rotate function control 1362 may include one or more hydraulic valves that may rotate the grapple 148 or prevent the grapple 148 from rotating. When the turn off rotate function 1360 is communicated to the grapple rotate function control 1362, the rotation of the grapple 148 may be stopped and the grapple 148 may be prevented from rotating out of the desired grapple orientation. The system may also include an actuator similar to the system 358 of FIG. 3c.

Input from a grapple free swing mode on/off button 1364 may also be communicated to the grapple free swing function control 1358. In one example, the grapple free swing mode on/off button 1364 may be located within the operator's cab 140. In other examples, the grapple free swing mode on/off button 1364 may be located remote relative to the swing machine 146. In some examples, the grapple free swing mode on/off button 1364 may be located on the input/output device 222, such as, for example, on the joystick or keyboard. The grapple free swing mode on/off button 395 may enable or disable the grapple free swing function control 1358. In some examples, the button 1364 may be selected by an operator.

FIG. A illustrates a first landing site 400 including a log pile 402, a swing machine 404, and a log truck 406. The swing machine 404 includes, among other things, a main frame 408 coupled to a first ground engaging unit 410, a second ground engaging unit 412, and an operator's cab 414. The main frame 408 is also coupled to a boom assembly 416 with a grapple 418 attachment. The grapple 418 may move between an open position, a closed position, and positions therebetween. The swing machine 404 may rotate between the log pile 402 and the log truck 406, thereby moving the boom assembly 416 and the grapple 418 between the log pile 402 and the log truck 406. An angle 420 may be formed between the log pile 402, the swing machine 404, and the log truck 406. In one implementation, the angle 420 may be 90°. In another example, the angle 420 may be between 60° and 90°. In another example, the angle may be between 30° and 60°. In yet another example, the angle 420 may be between 0° and 30°. In another example, the angle 420 may be greater than 90°. For example, the angle 420 may be between 90° and 120°. In another example, the angle 420 may be between 120° and 150°. In still another example, the angle 420 may be between 150° and 180°.

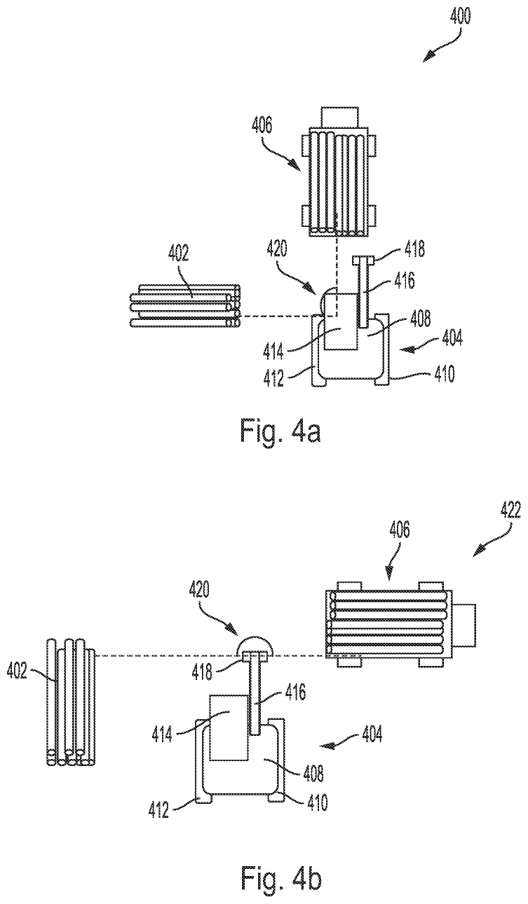

FIG. 4b, illustrates a second landing site 422 including the log pile 402, the swing machine 404, and the log truck 406, similar to FIG. 4a. The swing machine 404 in the second landing site 422 may rotate between the log pile 402 and the log truck 406, thereby moving the boom assembly 416 with the grapple 418 coupled thereto between the log pile 402 and the log truck 406. The second landing site 422 may also form an angle 420 between the log pile 402, the swing machine 404, and the log truck 406. In one example, the angle 420 may be 180°. In other examples the angle 420 may be between 180° and 240°. In other examples the angle 420 may be between 240° and 270°. In still other examples, the angle 420 may be between 270° and 360°.

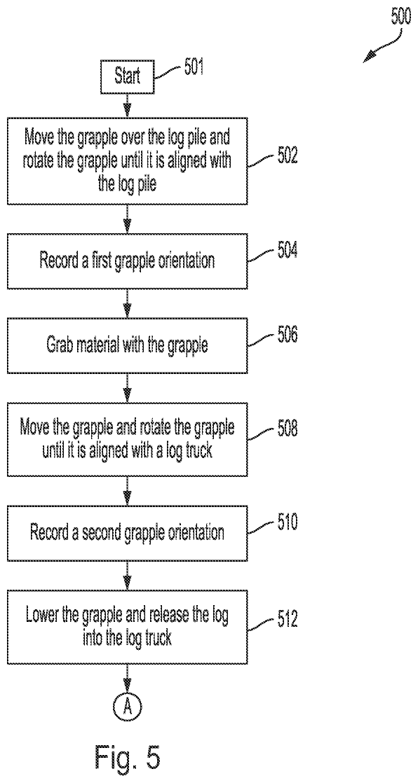

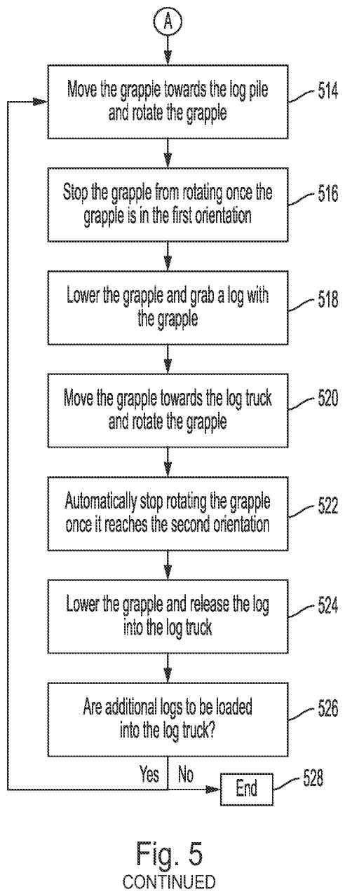

FIG. 5 is one implementation of a method 500 for moving the grapple 148 between a log pile 402 and a log truck 406 and specifically how to semi-automatically or automatically align the grapple 148 to a position. While the term log truck 406 is used herein, this method may apply to any log loading area, such as, for example, a log bunk of a forwarder. Beginning at block 501, an operator moves the grapple 148 towards a log pile and rotates the grapple 148, aligning the grapple 148 with the log pile (block 502). Once the grapple 148 is aligned with the log pile, the grapple orientation is recorded in block 504 and this orientation is also referred to as the first orientation. In one implementation the first orientation is measured when the grapple 148 is positioned above the log pile. However, in other implementations, the first orientation may also be measured when the grapple 148 is aligned with the log pile even if the grapple 148 is not positioned above the log pile. For example, the first orientation may be measured when the grapple 148 has been lowered into the log pile. The first orientation may be recorded before the grapple 148 grabs material, while the grapple 148 is grabbing material, or after the grapple 148 has grabbed material.

In one implementation, the operator may record the first orientation with the input/output device 222, such as, for example, with a button on the joystick. In some implementations, the sensor 150 may record the orientation of the grapple 148. After the first orientation is recorded, the first orientation may be communicated with the controller 202. In some examples, the input/output device 222 or the sensor 150 may communicate the first orientation to the controller 202. The first orientation input may be stored, among other ways, with the data storage 220 of the controller 202. In some examples, the operator may move the grapple from an open position to a closed position which may record the first position.

After recording the first grapple orientation in block 504, the grapple 148 may grab material, such as one or more logs in block 506. In one implementation, the first orientation may be may recorded when the grapple 148 is positioned above the material. In this implementation, the operator may record the first orientation before grabbing the material. In a second implementation, the operator may record the first orientation while the grapple 148 is being lowered. In a third implementation, the operator may record the first orientation after the grapple 148 has been lowered. In the third implementation, the grapple orientation may be recorded before or after the grapple 148 has grabbed material. In another implementation, the grapple orientation may be recorded while the grapple 148 is grabbing the material. The grapple may be in the open position, closed position, or a position therebetween when the first orientation is recorded in block 504.

While in method 500 the grapple 148 grabs the material block 506 after the first grapple orientation is recorded in block 504, it should be understood that, as explained above, block 506 may occur before the grapple orientation is recorded in block 504. After the grapple 148 grabs the material in block 506, the grapple 148 is moved towards the log truck 406 and the grapple 148 is rotated until the grapple 148 is aligned with the log truck 406 in block 508. After the grapple 148 is aligned with the log truck 406, the user may record a second grapple orientation in block 510, hereinafter referred to as a second orientation. In the illustrative implementation, the second orientation may be measured when the grapple 148 is aligned with the log truck 406 and when the grapple 148 is above the log truck 406. After the operator or user records the second orientation of the grapple in block 510, the operator may lower the grapple and release the one or more logs into the log truck in block 512.

While the second orientation may be recorded in block 510 before the grapple 148 is lowered towards the log truck 406 and before the grapple 148 releases the one or more logs into the log truck 406, the second orientation may also be recorded in block 510 after the operator lowers the grapple 148 towards the log truck 406. More specifically, after the operator grabs the material with the grapple 148 in block 506, moves the material towards the log truck and aligns the grapple 148 with the log truck in block 508, the operator may then lower the grapple 148 and release the material into the truck in block 512. Then, while the grapple 148 is still aligned with the log truck 406, the operator may record the second orientation. In some implementations, the second orientation may be measured after the grapple 148 is lowered into the log truck 406 but before the grapple 148 releases the material.

After the second grapple orientation is recorded in block 510 and the grapple 148 has released material into the truck in block 512, the grapple 148 may move towards the log pile and the grapple 148 may be rotated in block 514. The grapple 148 may be rotated to the first orientation using a semi-automatic mode or an automatic mode. In one implementation, the operator may use the semi-automatic mode to rotate the grapple 148 to the first orientation. In the semi-automatic mode, the grapple 148 may be temporarily actively rotated in block 514 and then the active rotation of the grapple 148 may be stopped before the grapple 148 reaches the first orientation. In this implementation, after the active rotation of the grapple 148 is stopped, the grapple 148 may be in free swing mode until it reaches the first orientation. While the grapple 148 is in free swing mode, the grapple 148 may rotate about the grapple rotational axis 152 without being pushed, stopped, or otherwise altered by the swing machine 146. Once the grapple 148 reaches the first orientation, the grapple 148 may be stopped or otherwise prevented from moving out of this orientation in block 516. In other words, free swing mode may be deactivated. In one example, once the grapple 148 is oriented in the first orientation, the controller 202 may deactivate free swing mode via a hydraulic valve. In one example, the controller 202 may automatically, with no input from the operator, prevent the grapple 148 from rotating to a different orientation. In other examples, input may be communicated to the controller commanding the controller 202 to prevent the grapple 148 from rotating to a different orientation. In some examples, the operator may instruct the controller to deactivate free swing mode.

In another implementation, the operator may move the grapple to the first orientation via the automatic mode. In this automatic mode, after the grapple 148 is lowered and releases the log into the log truck 406 in block 512, the operator may move the grapple 148 towards the log pile and the controller 202 may automatically actively rotate the grapple 148 to the first orientation in block 514. For example, the controller may actuate a hydraulic valve that may rotate the grapple 148 to the first orientation. Once the grapple 148 is rotated to the first orientation, the controller 202 may stop or otherwise prevent the grapple 148 from rotating out of the first orientation in block 516. In this automatic method the grapple 148 may not enter a free swing mode, and instead may be actively rotated into the first orientation and the grapple 148 may be at least temporarily maintained in that first orientation.

Once the grapple 148 is in the first orientation, it may be lowered into the log pile 402 and may grab material in block 518. Then the grapple 148 may move towards the log truck and the grapple 148 may be rotated to the second orientation in block 520. The operator may move the grapple to the second orientation using either the semi-automatic or automatic mode.

The semi-automatic mode may be used to move the grapple to the second orientation. As described above, the grapple 148 may be temporarily actively rotated and then the active rotation may stop and the grapple 148 may be in free swing mode. Once the grapple 148 rotates to the second orientation, the controller 202 may automatically stop the grapple in block 522 from rotating out of this orientation. In another implementation, the operator may use the automatic mode to move the grapple to the second orientation. In this implementation, as described above, the controller 202 may rotate the grapple 148 to the second orientation; stop rotating the grapple 148; and keep the grapple 148 in the second orientation in block 522.

After the grapple 148 is in the second orientation, the operator may lower the grapple 148 and release the log into the log truck 406 in block 524. After releasing the log into the log truck 406, the operator may then determine whether additional logs are to be loaded into the log truck 406. If more logs are to be loaded into the log truck 406, the operator continues the method 500 at block 514 by moving the grapple 148 towards the log pile 406 and rotating the grapple 148 in block 514. Alternatively, if no additional logs are to be loaded into the log truck, the method 500 may end in block 528.

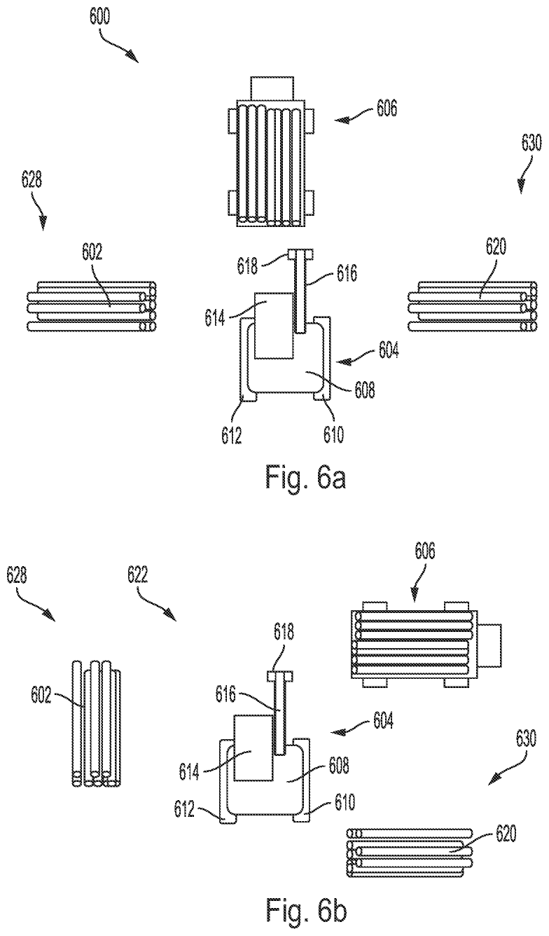

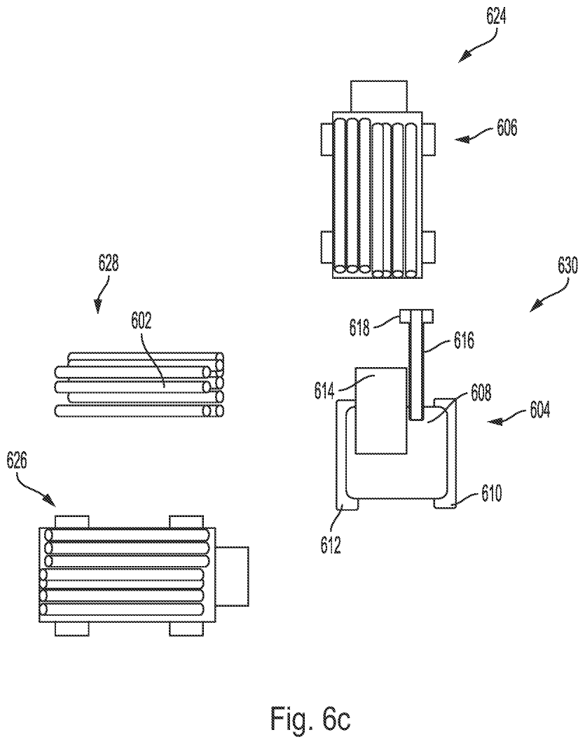

FIG. 6A provides an illustration of a third landing site 600, including a first log pile 602, a swing machine 604, a log truck 606, and a second log pile 620. The swing machine 604 may include a main frame 608 coupled to a first ground engaging unit 610, a second ground engaging unit 612, an operator's cab 614, and a boom assembly 616. The boom 616 assembly may have a grapple attachment 618. The landing site 600 may have a first side 628 and a second side 630. The first log pile 602 may be positioned along the first side 628, the second log pile 620 may be positioned in the second side 630, and the log truck 606 and swing machine 604 may be positioned between the first side 628 and the second side 630. In the third landing site 600, the swing machine 604 may rotate, thereby rotating the boom with the grapple 618 attachment. The grapple 618 may move between the first side 628, the second side 630, and any location therebetween. In some examples, the swing machine 604 may rotate between the first log pile 602, the log truck 606, and the second log pile 620.

In one example, the grapple 618 may pick up one or more logs from the first log pile 602, move to the log truck 606, drop the one or more logs in the log truck 606, then move to the second log pile 620 and pick up one or more logs, then return to the log truck 606 and drop the one or more logs in the log truck 606. In another example, the grapple 618 may pick up one or more logs from the first log pile 602, and may move to the log truck 606 to drop the one or more logs. Then, the grapple 618 may move back to the first log pile 602 and pick up one or more logs from the first log pile 602. In still another example, the grapple 618 may pick up one or more logs from the second log pile 620, move to the log truck 606 and drop the one or more logs in the log truck 606. Then, the grapple 618 may return to the second log pile 620 and pick up one or more logs.

FIG. 6B illustrates a fourth landing site 622 with the first and second log piles 602, 620, respectively, the log truck 606, and the swing machine 604. The first log pile 602 may be positioned along the first side 628 of the landing site 622, and the log truck 606 and second log pile 620 may be positioned along in the second side 630 of the fourth landing site 622. The swing machine 604 may be positioned between the first and second sides 628, 620 and may rotate therebetween. More specifically, the swing machine may rotate between the first log pile 602 located along the first side 628, the log truck 606 located on the second side 630, and the second log pile 620 located along the second side 630. While the swing machine 604 rotates between these positions, the boom assembly 616 with the grapple attachment 618 may also swing between these positions.

FIG. 6c illustrates a fifth landing site 624, including the log pile 602, the first log truck 606, a second log truck 626, and the swing machine 602. In this implementation, the log pile 602 and second log truck 626 may be positioned on the first side 628 of the fifth landing site 624 and the swing machine 604 and the first log truck 606 may be located between the first side 628 and the second side 630. In this implementation, the swing machine may rotate between the second log truck 626, the log pile 602, and the first log truck 606.

In some implementations, the swing machine 604 may move logs from more than two log piles to one or more log trucks. The swing machine 604 may also move logs between log piles. In other implementations, the swing machine 604 may unload the log truck, wherein the swing machine may take logs from one or more log trucks and drop them in one or more log piles. In addition to moving logs into log trucks, logs may be moved into any loading area, such as a log bunk 826 of a forestry forwarder 846 (see FIG. 8) or any other log loading area. While FIGS. 6c-6c illustrate particular landing site configurations, it should be understood that these are non-limiting examples and any configuration of one or more log trucks, one or more log piles, and one or more swing machines are considered herein.

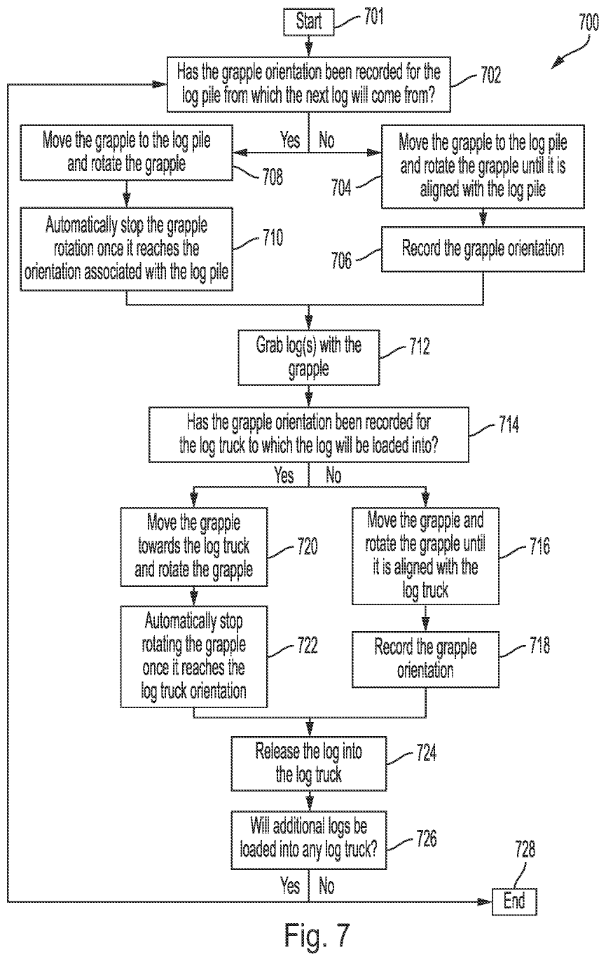

Referring now to FIG. 7, a method 700 of moving one or more logs from one or more log piles to one or more log trucks is provided. Beginning with block 701, a determination is made in block 702 as to whether the grapple orientation has been recorded for the log pile from which the next log will come from. If the grapple orientation for this log pile has not been recorded, then the method 700 advances to block 704 where the operator moves the grapple to the log pile and rotates the grapple 148 until it is aligned with the log pile. The grapple orientation may then be recorded in block 706. The grapple orientation may be recorded while the grapple 148 is positioned above the log pile, while the grapple 148 is lowering towards the log pile, or after the grapple 148 has been lowered to the log pile. The grapple orientation may be recorded before the grapple 148 grabs material from the log pile, while the grapple 148 is grabbing material from the log pile, or after the grapple 148 has grabbed material from the log pile.

In one implementation, the operator may record the first orientation with the input/output device 222, such as, for example, with the button on the joystick. In some implementations, the sensor 150 may record the orientation of the grapple 148. After the first orientation is recorded, the first orientation may be communicated to the controller 202. In some examples, the input/output device 222 or the sensor 150 may communicate the first orientation to the controller 202. The first orientation input may be stored with the data storage 220, for example.

Alternatively, if the grapple orientation has been recorded in block 702 for the log pile from which the next log will come from, the grapple 148 may then be moved to the log pile in block 708 and the grapple 148 may be rotated. The grapple 148 may be rotated using the semi-automatic mode or automatic mode. In one example, the operator may use the semi-automatic mode to rotate the grapple 148 to the desired log pile orientation. In the semi-automatic mode, the grapple 148 may be temporarily actively rotated and then the active rotation of the grapple 148 may stop before the grapple 148 reaches the desired log pile orientation. In this implementation, after the operator stops actively rotating the grapple 148, the grapple 148 may be in free swing mode until it reaches the desired log pile orientation. While the grapple is in free swing mode it may continue to rotate freely with no active force actively rotating, pushing, or stopping the grapple 148 from rotating. Once the grapple 148 reaches the desired log pile orientation, the grapple 148 may be stopped or otherwise prevented from moving out of this orientation in block 710. In one example, once the grapple 148 is oriented in the desired log pile orientation, the controller 202 may prevent the grapple 148 from rotating to a different orientation. In some examples, the controller 202 may automatically prevent the grapple 148 from rotating to a different orientation via a hydraulic valve. In other examples, the controller 202 may be commanded to prevent the grapple 148 from rotating to a different orientation.

In another implementation, the operator may move the grapple to the desired log pile orientation via the automatic mode. Using the automatic mode, after the grapple 148 is moved to the log pile, the controller 202 may automatically rotate the grapple 148 to the desired log pile orientation in block 710. In one example, the controller 202 may actuate a hydraulic valve (not pictured) that may actively rotate the grapple 148 to the desired log pile orientation. Once the grapple 148 is rotated to the desired log pile orientation, the controller 202 may stop or prevent the grapple 148 from rotating out of the desired log pile orientation in block 710. In some examples, the controller 202 may stop the grapple 148 from rotating out of the desired log pile orientation in block 710 via the hydraulic valve.

Once the grapple 148 is in the orientation that is aligned with the desired log pile orientation in block 710 or the grapple orientation has been recorded in block 706, the grapple 148 may then grab one or more logs in block 712. Then, it is determined whether the grapple orientation has been recorded for the log truck to which the log will be loaded into in block 714. If the grapple orientation has not yet been set for the desired log truck in block 714, then the grapple 148 may be moved towards the log truck and may be rotated until it is aligned with the log truck in block 716.

The grapple orientation may then be recorded in block 718. The grapple orientation may be recorded while the grapple 148 is located above the log truck, while the grapple 148 is being lowered towards the log truck, or after the grapple 148 has been lowered towards the log truck. As described above, the grapple orientation may be recorded with the input/output device 222, such as with a button on the joystick, or via the sensor 150. The first orientation may be communicated to the controller 202 and the input may be stored. In one implementation, the operator may record the first orientation with the input/output device 222, such as, for example, with the button on the joystick. In some implementations, the sensor 150 may record the orientation of the grapple 148. After the first orientation is recorded, the first orientation may be communicated to the controller 202. In some examples, the input/output device 222 or the sensor 150 may communicate the first orientation to the controller 202. The first orientation input may be stored, among other ways, with the data storage 220 of the controller 202.

Alternatively, if the grapple orientation has been recorded for the desired log truck orientation in block 714, then the grapple 148 may be moved towards the log truck and rotated in block 720. The grapple 148 may be rotated into the desired log truck orientation via the semi-automatic or the automatic mode, both of which are described above. Regardless of whether the semi-automatic or automatic mode is used to rotate the grapple 148, the grapple 148 will automatically be stopped from rotating once it reaches the desired log truck orientation in block 722.

Once the grapple 148 has been automatically stopped rotating and is in the orientation associated with the desired log truck orientation in block 722 or the grapple orientation has been recorded in block 718, the grapple 148 may then release the one or more logs into the log truck in block 724. Next, a determination is made as to whether additional logs will be loaded into any log truck in block 726. If no more logs are to be loaded into any log truck, then the method 700 may end in block 728. If additional logs will be loaded into any log truck, then a determination is made as to whether the grapple orientation has been recorded for the log pile from which the next log will come from in block 702 and the method 700 proceeds as described above.

The method and the system according to the present disclosure may be applied in a variety of work machines 100, including a forwarder 846 as illustrated in FIG. 8 as well as the swing machine 146 of FIGS. 1a and 1b. Referring now to FIG. 8, a forestry forwarder 846 is illustrated and includes an undercarriage 802 with four ground engaging units 804, 805, 806, 807. The forwarder 846 may further include a main frame 808 supported from the undercarriage 802 by a swing bearing 810 such that the main frame 808 is pivotable about a pivot axis 812 relative to the undercarriage 802. The pivot axis 812 may be substantially vertical when a ground surface 814 is substantially horizontal. A swing motor (not shown) may be configured to pivot the main frame 808 on the swing bearing 810 about the pivot axis 812 relative to the undercarriage 802.

The main frame 808 may be coupled to a log bunk 826, and the log bunk 826 may have a frame 828 with four ground engaging units 830, 832, 834, 836. The log bunk frame 828 may be coupled to two or more stakes 860 which may define a cargo area configured to store one or more logs. A boom 820 may be pivotally coupled to the log bunk main frame 828 to pivot about a generally horizontal axis relative to the main frame 828. A working tool 824 may be pivotally coupled to a boom arm 822. In one implementation, as illustrated in FIG. 8, the working tool 824 may be a grapple 848. The grapple 848 may be moveably coupled to the boom arm 822. The working tool 824 may also be any working tool, forestry head, or forestry attachment known in the art, such as, for example, a felling head, harvesting head, log fork, grapple, or Waratah head, among others. The boom assembly 818 may extend from the main frame 828 along a working direction of the boom assembly 818. The working direction can also be described as a working direction of the boom 820. As described herein, control of the work implement 816 may relate to control of any one or more of the associated components (e.g., boom 820, boom arm 822, and working tool 824).

As illustrated in FIG. 8, in some implementations the ground engaging units 804, 805, 806, 807 may be wheels. In one implementation, the ground engaging units 804, 805, 806, 807 may be tracked ground engaging units. While four ground engaging units are illustrated in FIG. 8, the main frame 808 may have two ground engaging units, three ground engaging units, or more than four ground engaging units. As illustrated, the log bunk ground engaging units 830, 832, 834, 836 may also be wheels. In some implementations, the log bunk ground engaging units 830, 832, 834, 836 may be tracked ground engaging units. While four ground engaging units are described herein, the log bunk frame 828 may have two ground engaging units, three ground engaging units, or more than four ground engaging units.

Each main frame 808 ground engaging unit 804, 805, 806, 807 has a first forward traveling direction 838 defined from the second ground engaging unit 805 to the first ground engaging unit 804. The forward traveling direction 838 of the ground engaging units 804, 805, 806, 807 also defines a forward traveling direction 838 of the undercarriage 802 and thus of the main frame 808 of the forwarder 846. Likewise, the log bunk 826 ground engaging units 830, 832, 834, 836 have a second forward traveling direction 862 defined from the second log bunk wheel 832 to the first log bunk wheel 830. The forward traveling direction 862 of the ground engaging units 804, 805, 806, 807 also defines a forward traveling direction 862 of the log bunk 826 of the forwarder 846.

An operator's cab 840 may be located on the main frame 808. The operator's cab 840 may be mounted on the main frame 808 and a control station 842 may be located in the operator's cab 840. An engine 844 may also be mounted to the main frame 808 such that the engine 844 powers the forwarder 846. In some implementations, the engine 844 may be a diesel internal combustion engine. The engine 844 may also drive a hydraulic pump to provide hydraulic power to various operating systems of the forwarder 846.

The forwarder 846 may also include a sensor 850. In one example, the grapple 848 may be coupled to one or more sensors 850, and the grapple 848 may rotate about a grapple pivot axis 852. The one or more sensors 850 may detect one or more characteristics and/or orientations of the grapple 848. For example, the one or more sensors 850 may detect the rotational position of one or more of the grapple arms 854, 856 about the grapple pivot axis 852. The one or more sensors 850 may also detect the vertical position of the grapple 848 relative to the ground surface 814, referred to herein as grapple height. In some examples, the one or more sensors 850 may detect the position of the grapple 848 relative to the main frame 808 of the work machine 800, such as, for example, the horizontal distance the grapple 848 is located relative to the main frame 808 In another example, the one or more sensors 850 may be coupled to another part of the work machine, other than the grapple 848, and the one or more sensors 850 may detect one or more of the height or orientation of the grapple 848. In some examples, the one or more sensors 850 may sense whether the grapple 848 is in an open position or in a closed position. In other examples, the one or more sensors 850 may detect whether the grapple 848 is carrying a load. The work machine 800 may also have one or more sensors 850 that can determine the position of the work machine 800 or the positions of one or more components of the work machine 800. Thus, the one or more sensors 850 may detect a position and/or a change in position of the work machine 800 or a change in position of one or more components of the work machine 800. In some examples, the one or more sensors 800 may have GPS capabilities, and the GPS location of one or more of the grapple 848 or the work machine 800 may be detected. In some examples, the one or more sensors 850 may detect the positional orientation of the grapple 848, and the positional orientation may include one or more of the grapple position relative to the ground surface 814, the grapple position relative to the swing machine 846, or the GPS position of the grapple 848, the swing machine 846, or both the grapple 848 and the swing machine 846.

While the above describes example implementations of the present disclosure, these descriptions should not be viewed in a limiting sense. Rather, other variations and modifications can be made without departing from the scope and spirit of the present disclosure as defined in the appended claims.

What is claimed is:

1. A forestry work machine comprising:
a frame supported by at least one ground engaging mechanism;
a boom coupled to the frame and configured to move relative to the frame;
a working tool coupled to the boom and configured to perform a work function;
a controller for controlling movement of the boom and working tool; and
a sensor communicatively coupled to the controller, the sensor configured to detect a characteristic of the working tool;
wherein, when the working tool is in a first position, the sensor detects the characteristic of the working tool and communicates the characteristic to the controller;
wherein the controller stores the characteristic as a first set point;
wherein, when the working tool is displaced from the first position and the controller receives a command to return the working tool to the first position, the controller operatively controls movement of the working tool to the first position based on the first set point.

2. The forestry work machine of claim 1, wherein the sensor is configured to detect a second characteristic of the working tool at a second position and communicate the second position to the controller;
wherein the controller stores the second characteristic as a second set point;
wherein, when the working tool is displaced from the second position and the controller receives a command to return the working tool to the second position, the controller operatively controls movement of the working tool to the second position based on the second set point.

3. The forestry work machine of claim 1, wherein the controller operably moves the working tool via an automatic mode, wherein during the automatic mode the controller automatically moves the working tool to the first position without manual intervention.

4. The forestry work machine of claim 1, wherein the controller moves the working tool via a semi-automatic mode, wherein during the semi-automatic mode the controller is configured to enable a free swing mode until the working tool reaches the first position and disables the free swing mode once the working tool reaches the first position.

5. The forestry work machine of claim 2, wherein the characteristic of the working tool includes one or more of a rotational orientation of the working tool, an open or closed status of the working tool, a distance the working tool is relative to the frame, a position of the working tool relative to the frame, and a height of the working tool relative to a ground surface.

6. The forestry work machine of claim 1, wherein the working tool comprises a grapple.

7. The forestry work machine of claim 1, wherein the sensor comprises one or more of a position sensor, proximity sensor, pressure sensor, motion sensor, image sensor, ultrasonic sensor, or GPS sensor.

8. The forestry work machine of claim 1, further comprising a free swing function button disposed in communication with the controller, wherein when the free swing button is actuated, the controller is configured to transition the working machine into or out of a free swing mode.

9. The forestry work machine of claim 8, wherein the controller is configured to prioritize an instruction received from the free swing function button over an input received from the sensor.

10. A method for moving material via a forestry work machine from a first area to a second area, the forestry work machine including a boom, a working tool, and a controller, the method comprising:
moving a working tool connected to the boom via the controller to a first position in the first area;
storing, via the controller, a first characteristic of the working tool at the first position as a first set point;
collecting the material with the working tool;
moving the working tool via the controller to a second position in the second area;
storing, via the controller, a second characteristic of the working tool at the second position as a second set point; and
actuating the working tool via the controller to release the material in the second area.

11. The method of claim 10, further comprising:
controllably moving the working tool via the controller towards the first area and in the first position based on the first set point;
automatically stopping the working tool from moving once the working tool is in the first position based on the first set point;
controllably lowering the working tool via the controller and collecting the material with the working tool;
controllably moving the working tool via the controller towards the second area and moving the working tool to the second position based on the second set point;
automatically stopping the movement of the working tool via the controller once the working tool reaches the second position; and
lowering the working tool and releasing the material into the second area.

12. The method of claim 11, wherein controllably moving the working tool to the first and second positions is done via an automatic mode or a semi-automatic mode.

13. The method of claim 12, wherein, in the automatic mode, the method comprises:
enabling, via the controller, a rotate function that actively moves the working tool to the first or second set point, and
disabling, via the controller, the rotate function when the working tool is in the first or second set point.

14. The method of claim 12, wherein, in the semi-automatic mode, the method comprises:
activating, via the controller, a free swing function when the working tool is not in the first or second set point; and
deactivating, via the controller, the free swing function once the working tool reaches the first or second set point.

15. The method of claim 10, wherein the storing the first characteristic or the second characteristic of the working tool in the controller comprises storing one or more of a rotational orientation of the working tool, an open or closed status of the working tool, a distance the working tool is relative to the frame, a position of the working tool relative to the frame, and a height of the working tool relative to a ground surface.

16. A method for moving a material into an area via a forestry work machine, the forestry work machine including a working tool and a controller, the method comprising:
performing a first operation by controlling the working tool to move to a first location and collect a first load of material;
storing a first characteristic of the working tool at the first location in the controller;
controllably moving, via the controller, the working tool to a second location and recording a second characteristic of the working tool at the second location as a second set point in the controller;
maintaining the working tool at the second set point until a command is received by the controller to move the working tool from the second set point and release the material at the second location;
moving the working tool via the controller from the second location to the first location based on the first set point; and
performing a second operation by controlling the working tool to collect a second load of material from the first area.

17. The method of claim 16, wherein the first operation comprises:
controllably moving the working tool to a first position via the controller based on the first set point; and
maintaining the working tool at the first set point until a command is given to move the working tool from the first set point.

18. The method of claim 17, wherein the method comprises:
controllably moving the working tool via the controller by activating a free swing mode; and
automatically deactivating via the controller the free swing mode once the working tool reaches the first or second set point.

19. The method of claim 17, further comprising rotating, via the controller, the working tool to the first or second set point.

20. The method of claim 16, wherein the storing the first characteristic or the second characteristic of the working tool in the controller comprises storing one or more of a rotational orientation of the working tool, an open or closed status of the working tool, a distance the working tool is relative to the frame, a position of the working tool relative to the frame, and a height of the working tool relative to a ground surface.
